(19) United States
(12) Patent Application Publication
(10) Pub. No.: US 2026/0156728 A1
(43) Pub. Date: Jun. 4, 2026

(54) LIGHTING DEVICE AND CIRCUIT CAPABLE OF INDICATING LIGHTING LIFESPAN

(71) Applicant: SAVANT TECHNOLOGIES LLC, East Cleveland, OH (US)

(72) Inventors: Kun XIAO, Shanghai (CN); Jie GAO, Shanghai (CN); Yimin ZHU, Shanghai (CN); Abhinav BHANDARI, Rockledge, FL (US)

(73) Assignee: SAVANT TECHNOLOGIES LLC, East Cleveland, OH (US)

(21) Appl. No.: 19/311,273

(22) Filed: Aug. 27, 2025

(30) Foreign Application Priority Data
Sep. 23, 2024 (CN) 202422323528.4

(51) Int. Cl. H05B 45/58; F21K 9/238

(52) U.S. Cl. CPC H05B 45/58; F21K 9/238

(57) ABSTRACT

Provided is a lighting device and a circuit, the lighting device includes a lighting diode having a rated lighting lifespan, and the lighting diode being connected to an external power source to receive power from the external power source to emit light, a controller, connected to the lighting diode so as to accumulate a lighting duration of the lighting diode when the lighting diode receives power to emit light, and an indication diode connected between the controller and a negative electrode of the external power source to receive a control signal from the controller, when the accumulated lighting duration is equal to or greater than the rated lighting lifespan, the control signal is sent, to effectively indicate the lifespan condition of the lighting device, to avoid potential safety risks of the lighting device, eye fatigue of the user, and improve the sales of the lighting device.

### CROSS-REFERENCE TO RELATED APPLICATIONS

This application claims priority to Chinese Patent Application Serial Number 202422323528.4, filed Sep. 23, 2024, which is herein incorporated by reference.

### TECHNICAL FIELD

The present disclosure relates to the field of lighting, and in particular, relates to a lighting device and a circuit which are capable of indicating lighting lifespan.

### BACKGROUND

Generally, the rated lifespan of lighting devices (or LED lamps) is between 10,000 hours and 50,000 hours. At the end of life, the lighting device has a safety risk. Firstly, the lumen (representing the total amount of light emitted by a light source) drops significantly; and secondly, there may be smoke or fire phenomenon in the lighting device.

In order to solve the safety risk of the lighting device at the end of life, the present disclosure proposes a lighting device and a circuit which are capable of indicating lighting lifespan, the lighting device and circuit use an LED lamp provided as a lifespan indicator; the lifespan indicator gives a prompt when the lighting device reaches a rated lifespan, such that a user performs operations, such as detection, maintenance, or replacement, etc. on the lighting device reaching the rated lifespan, so as to avoid potential safety risks of the lighting device, avoid eye fatigue of the user, and improve the sales volume of the lighting device.

By means of the described design, the lighting device and circuit of the present disclosure can effectively indicate the lifespan condition of the lighting device to a user, and help the user take measures in time.

### SUMMARY OF THE INVENTION

In view of this, the present disclosure aims to provide an improved lighting device and circuit, which can accumulate a lighting duration of a lighting diode by a controller, and indicate by an indication diode that the accumulated lighting duration is equal to or greater than a rated lighting lifespan, thereby effectively indicating the lifespan condition of the lighting device to a user, so as to avoid potential safety risks of the lighting device, avoid eye fatigue of the user, and improve the sales volume of the lighting device.

According to one aspect of the present disclosure, provided is a lighting device capable of indicating a lighting lifespan, the lighting device comprising: a lighting diode, having a rated lighting lifespan, and the lighting diode being connected to an external power source to receive power from the external power source to emit light; a controller, connected to the lighting diode so as to accumulate a lighting duration of the lighting diode when the lighting diode receives power to emit light; and an indication diode, connected between the controller and a negative electrode of the external power source to receive a control signal from the controller, wherein the control signal controls the on, off or brightness change of the indication diode; wherein the controller compares the rated lighting lifespan and the accumulated lighting duration of the lighting diode, and when the accumulated lighting duration is equal to or greater than the rated lighting lifespan, the control signal is sent.

In this way, the lighting duration of the lighting diode is accumulated by the controller, and the accumulated lighting duration being equal to or greater than the rated lighting lifespan is indicated by the indication diode, and thus the present disclosure can simply and effectively indicate the lifespan condition of the lighting diode by the indication diode, so as to avoid potential safety risks of the lighting device, avoid eye fatigue of the user, and improve the sales volume of the lighting device.

According to exemplary embodiments of the present disclosure, the lighting device further comprises an MOS transistor, wherein a source of the MOS transistor is connected to the lighting diode, a gate thereof is connected to the controller and a drain thereof is connected to the indication diode, so as to adjust a current flowing through the indication diode.

In this way, the MOS transistor, as a current controller, can effectively adjust the brightness of the lighting diode, thereby realizing the adjustment and control of the lighting effect; and by adjusting the connection between the drain and the indication diode, accurate control of the current of the indication diode can be realized, and brightness adjustment under different lighting requirements is satisfied. However, the present disclosure may also replace the MOS transistor with a triode.

According to exemplary embodiments of the present disclosure, the lighting device further comprises a bridge rectifier connected between the external power source and the lighting diode, the bridge rectifier rectifying an alternating current of the external power source to a direct current adapted to the lighting diode.

In this way, the bridge rectifier can convert the alternating current of the external power source into the direct current, which can eliminate current fluctuations and ensure stable operation of the lighting diode.

According to exemplary embodiments of the present disclosure, the lighting device further comprises a lighting power supply module connected between a positive electrode of the external power source and a positive electrode of the lighting diode, wherein the lighting power supply module supplies power to the lighting diode.

According to exemplary embodiments of the present disclosure, the lighting power supply module is a constant current source, such that a current flowing through the lighting diode is constant.

In this way, the lighting power supply module can effectively control the operating current of the lighting diode, and can provide a stable current output, thereby avoiding the occurrence of unstable operation or damage to the lamp due to voltage fluctuations or other external factors.

According to exemplary embodiments of the present disclosure, the controller is a microcontroller unit, and when the accumulated lighting duration is equal to or greater than the rated lighting lifespan, a relevant port state of the microcontroller unit changes to indicate that the indication diode is turned on.

According to exemplary embodiments of the present disclosure, the lighting device further comprises a controller power supply module connected between a positive electrode of the external power source and the controller, wherein the controller power supply module converts a current from the external power source to drive the controller.

In this way, the controller power supply module can convert a current from the external power source into a current suitable for the controller, satisfying different lighting requirements of the user, and providing assurance for a comfortable, energy-saving and safe lighting environment.

According to exemplary embodiments of the present disclosure, the number of the lighting diodes is one or more.

According to exemplary embodiments of the present disclosure, when there are a plurality of lighting diodes, the plurality of lighting diodes are connected in series or in parallel.

In this way, by connecting the plurality of lighting diodes in series or in parallel, the functions of dimming and color adjustment of lamp light can be realized, the flexibility and applicability of the lamp light are improved, and the lighting requirements under different scenarios and needs are satisfied.

According to exemplary embodiments of the present disclosure, the lighting diodes comprise red diodes emitting red light, green diodes emitting green light, or blue diodes emitting blue light.

In this way, the lighting diodes can emit light of various colors, such as red, green and blue, and can mix light of different colors according to requirements, thereby realizing a rich and colorful lighting effect

According to exemplary embodiments of the present disclosure, the indication diode is one indication diode, or a plurality of indication diodes connected in series.

In this way, the indication diode is a simple and effective component for displaying a circuit state. By changing the brightness or color thereof, whether the circuit works normally can be quickly determined; connecting a plurality of indication diodes in series can achieve a richer data display function. For example, by arranging a plurality of indication diodes with different colors, different states or values may be displayed.

According to exemplary embodiments of the present disclosure, the lighting device is a bulb, the lighting diode is located inside a bulb housing of the bulb, and the indication diode is located at a position near the bulb housing of the bulb.

In this way, placing the lighting diode inside the bulb housing of the bulb can effectively improve the lighting effect, making the light more uniform and soft. In addition, such an arrangement can also improve the practicality and diversity of the bulb.

According to exemplary embodiments of the present disclosure, the lighting diode is located on a circuit board within the bulb housing, and the indication diode is located at a position on an edge of the circuit board and near the bulb housing.

According to exemplary embodiments of the present disclosure, a part of the bulb housing close to the indication diode is transparent, such that the state of the indication diode can be observed.

According to exemplary embodiments of the present disclosure, the lighting diode is located on a circuit board inside the bulb housing, the indication diode is located inside an insulation body of the bulb, and a part of the insulation body is transparent, such that the state of the indication diode can be observed.

According to exemplary embodiments of the present disclosure, the controller is connected in parallel to the lighting diode, and the indication diode is arranged on a parallel branch where the controller is located.

According to another aspect of the present disclosure, provided is a circuit capable of indicating a lighting lifespan, the circuit comprising a power source and the lighting device as described above.

In the embodiments of the present disclosure, a technical solution, in which the lighting duration of the lighting diode is accumulated by the controller, and the accumulated lighting duration being equal to or greater than the rated lighting lifespan is indicated by the indication diode, is provided, which at least solves the technical problem in the prior art that a lighting device has a safety risk at the end of life, thereby achieving the technical effects of simply and effectively indicating the lighting lifespan, avoiding potential safety risks of the lighting device, avoiding eye fatigue of the user, and improving the sales volume of the lighting device.

### BRIEF DESCRIPTION OF THE DRAWINGS

The drawings illustrated herein are used for providing further understanding of the present utility model, constitute a part of the present application; and illustrative embodiments of the present application and illustrations thereof are used for explaining the present application, rather than constitute inappropriate limitations on the present application. In the drawings:

FIG. 1 is a schematic diagram showing a circuit capable of indicating a lighting lifespan according to embodiments of the present disclosure.

FIG. 2 is a schematic diagram showing a circuit capable of indicating a lighting lifespan according to another embodiment of the present disclosure.

FIG. 3 is a schematic diagram showing a structure in which a lighting diode is located within a bulb.

### DETAILED DESCRIPTION

Hereinafter, embodiments of the present application will be described in detail with reference to the accompanying drawings, such that a person skilled in the art could easily implement the embodiments of the present application. The present application may, however, be embodied in many different forms, and should not be construed as limited to the embodiments set forth herein. In the drawings, parts irrelevant to the illustration of the present application will be omitted for clarity. Similar reference numerals refer to similar elements throughout the illustration. In addition, when the illustration with reference to the drawings is provided, although elements are denoted by the same numeral, the reference numerals involving the elements may be changed; and the reference numerals are illustrated only for convenience of illustration, and should not be understood as limiting the concept, features, functions, or effects of the elements.

In practical applications, when the accumulated lighting duration of a lighting device (or LED lamp) is equal to or greater than a rated lighting lifespan, not only the lumen drops, but also safety hazards such as smoke or fire may occur, insufficient brightness may cause eye fatigue of a user, and the lighting device has a low sales volume.

Therefore, it is crucial how to determine whether the lighting device has reached the rated lighting lifespan and how to indicate that the rated lighting lifespan has been reached.

To this end, the present disclosure proposes an improved lighting device and circuit which are capable of indicating a lighting lifespan, in which when the accumulated lighting duration is equal to or greater than the rated lighting lifespan, the lighting device and circuit can control an indication diode to perform an indication, thereby facilitating the user in checking, repairing or replacing the lighting device according to the indication.

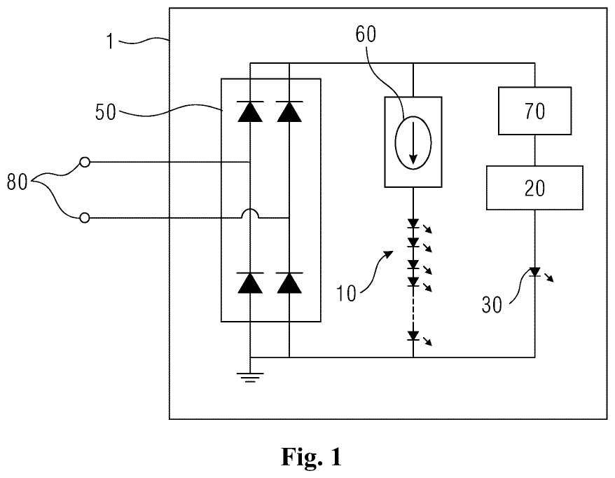

FIG. 1 is a schematic diagram showing a circuit capable of indicating a lighting lifespan according to embodiments of the present disclosure.

The circuit capable of indicating a lighting lifespan comprises a power source 80 and a lighting device 1. The types of the power source 80 may comprise a renewable energy source, a portable power source, and the like, and the present disclosure is not limited thereto. The voltage of the power source 80 may be 220V, 380V, or the like.

The lighting device 1 may be electrically connected to the power source 80 via a conductive wire. The lighting device 1 may also be wirelessly connected to the power source 80.

The lighting device 1 comprises a lighting diode 10, a controller 20, an indication diode 30, a bridge rectifier 50, a lighting power supply module 60, and a controller power supply module 70.

The lighting diode 10 has a rated lighting lifespan, for example, 10,000 to 50,000 hours, and the lighting diode is connected to the external power source 80 to receive power from the external power source 80 to emit light.

The lighting diode 10 can convert electric energy into light energy. The lighting diode has advantages of high efficiency, long lifespan, low energy consumption, etc., and is thus widely applied in the field of lighting. Common lighting diodes comprise LEDs (Light Emitting Diodes), etc.

Generally, after an accumulated lighting duration of the lighting diode 10 reaches a rated lighting lifespan, the lighting diode 10 can still emit light continuously, but the emitted light is weakened, and safety risks such as smoke or fire occur.

The controller 20 is connected to the lighting diode 10 so as to accumulate the lighting duration of the lighting diode 10 when the lighting diode 10 receives power to emit light. For example, the controller 20 is connected in parallel to the lighting diode 10.

The controller 20 is, for example, a microcontroller unit (MCU), and comprises a processor, a memory, and an oscillator. After the controller 20 receives power, the oscillator generates a stable clock signal, the processor performs operations such as calculation and logic determination according to instructions in a program, and the memory is used to store program codes, data and intermediate results. The processor, memory, and oscillator in the controller 20 work together to implement a control function.

The indication diode 30 is connected between the controller 20 and a negative electrode of the external power source 80 to receive a control signal from the controller 20, wherein the control signal controls the on, off or brightness change of the indication diode 30. For example, the indication diode 30 is arranged on a parallel branch where the controller 20 is located.

The indication diode 30 is a simple and effective component for displaying a circuit state, and by changing the brightness or color thereof, whether the circuit works normally can be quickly determined.

For example, in an initial state, the indication diode 30 is in an on state and emits light, and the controller 20 compares the rated lighting lifespan and the accumulated lighting duration of the lighting diode 10; and when the accumulated lighting duration is equal to or greater than the rated lighting lifespan, the controller 20 sends a control signal to the indication diode 30, the control signal controls the indication diode 30 to turn off, such that the current lifespan condition of the lighting diode is indicated to the user by the turning off of the indication diode 30.

For example, in the initial state, the indication diode 30 is in an off state and does not emit light, and the controller 20 compares the rated lighting lifespan and the accumulated lighting duration of the lighting diode 10; and when the accumulated lighting duration is equal to or greater than the rated lighting lifespan, the controller 20 sends a control signal to the indication diode 30, the control signal controls the indication diode 30 to turn on and emit light, such that the current lifespan condition of the lighting diode is indicated to the user by the turning on of the indication diode 30.

For example, in the initial state, the indication diode 30 is in an on state and emits light, and the controller 20 compares the rated lighting lifespan and the accumulated lighting duration of the lighting diode 10; and when the accumulated lighting duration is equal to or greater than the rated lighting lifespan, the controller 20 sends a control signal to the indication diode 30, the control signal controls brightness change of the indication diode 30, such that the current lifespan condition of the lighting diode is indicated to the user by the brightness change of the indication diode 30.

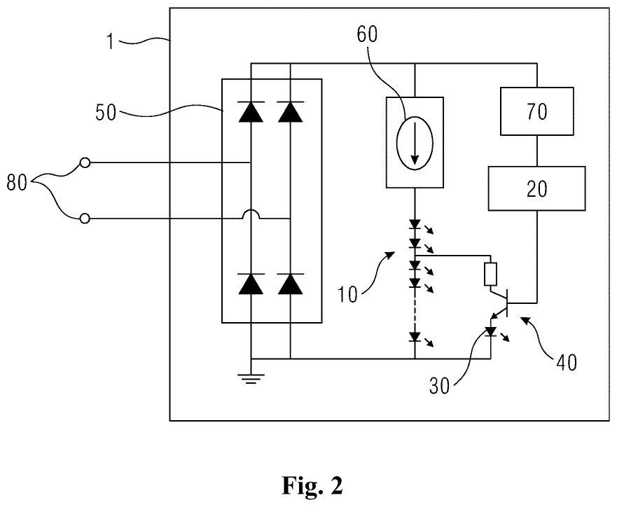

FIG. 2 is a schematic diagram showing a circuit capable of indicating a lighting lifespan according to another embodiment of the present disclosure.

This embodiment differs from the embodiment shown in FIG. 1 in that: in FIG. 2, the lighting device 1 further comprises an MOS transistor 40; wherein a source of the MOS transistor is connected to the lighting diode 10, a gate thereof is connected to the controller 20 and a drain thereof is connected to the indication diode 30, so as to adjust a current flowing through the indication diode 30.

The MOS transistor, as a current controller, can effectively adjust the brightness of the lighting diode 30, thereby realizing the adjustment and control of the lighting effect; and by adjusting the connection between the drain and the indication diode 30, accurate control of the current of the indication diode 30 can be realized, and brightness adjustment under different lighting requirements is satisfied.

For example, compared with the case in which the controller 20 directly supplies power to the indication diode 30 as shown in FIG. 1, when the MOS transistor is used, the current supplied to the indication diode 30 is increased, and the brightness of the indication diode 30 for emitting light is increased, thereby enhancing the indication effect.

The present disclosure may also adopt a triode to replace the MOS transistor above, and the present disclosure is not limited thereto.

In the embodiment shown in FIG. 1 or the embodiment shown in FIG. 2, the lighting device 1 further comprises the bridge rectifier 50 connected between the external power source 80 and the lighting diode, the bridge rectifier 50 rectifying an alternating current of the external power source 80 to a direct current adapted to the lighting diode 10.

The bridge rectifier 50 is composed of four diodes, which can not only rectify the alternating current into the direct current adapted to the lighting diode 10, but also can eliminate fluctuations in the current, so as to determine that the lighting diode 10 operates stably.

The lighting device 1 further comprises the lighting power supply module 60 connected between a positive electrode of the external power source 80 and a positive electrode of the lighting diode 10. The lighting power supply module 60, for example, can serve as a constant current source, such that the current flowing through the lighting diode 10 is constant, thereby avoiding the occurrence of unstable operation or damage to the lamp due to voltage fluctuations or other external factors.

The lighting device 1 further comprises the controller power supply module 70 connected between the positive electrode of the external power source 80 and the controller 20. The controller power supply module 70 converts a current from the external power source 80 to drive the controller 20, so as to satisfy different lighting requirements of a user, and provide assurance for a comfortable, energy-saving and safe lighting environment.

In the present disclosure, the number of the lighting diodes 10 is one or more; and when there are a plurality of lighting diodes 10, the plurality of lighting diodes 10 are connected in series or in parallel.

In the present disclosure, by connecting the plurality of lighting diodes 10 in series or in parallel, the functions of dimming and color adjustment of lamp light can be realized, the flexibility and applicability of the lamp light are improved, and the lighting requirements under different scenarios and needs are satisfied.

In the present disclosure, the lighting diodes 10 comprise red diodes emitting red light, green diodes emitting green light, or blue diodes emitting blue light.

The lighting diodes 10 can emit light of various colors, such as red, green and blue, and can mix light of different colors according to requirements, thereby realizing a rich and colorful lighting effect.

In the present disclosure, the indication diode 30 is one indication diode, or a plurality of indication diodes connected in series.

In the present disclosure, the operation condition of the circuit can be determined quickly by changing the brightness or color of the indication diode 30; and connecting a plurality of indication diodes 30 in series can achieve a richer data display function. For example, by arranging a plurality of indication diodes 30 with different colors, different states or values may be displayed, and can further refine the lifespan conditions of the lighting diodes 10.

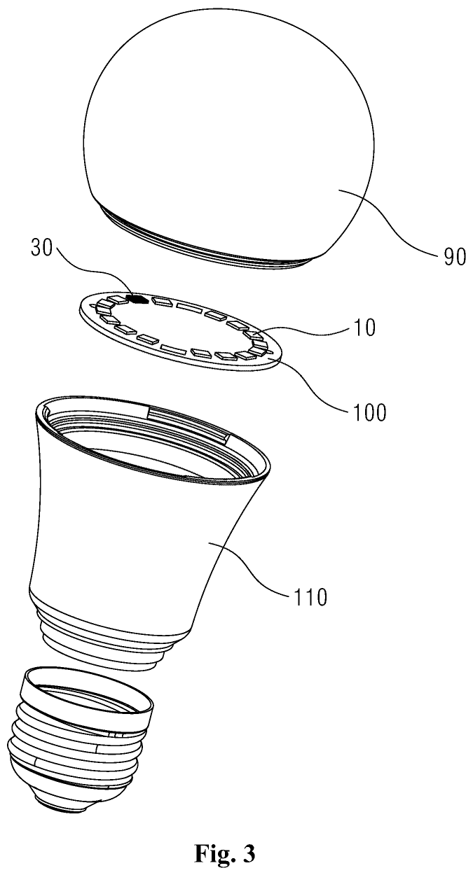

In addition, as shown in FIG. 3, the lighting device may be a bulb, the lighting diode 10 is located inside a bulb housing 90 of the bulb, and the indication diode 30 is located at a position near the bulb housing 90 of the bulb. In particular, the lighting diode 10 is located on a circuit board 100 within the bulb housing 90, and the indication diode 30 is located at a position on an edge of the circuit board 100 and near the bulb housing 90. A plurality of diodes are placed on the circuit board 100, in which one diode is set as the indication diode 30, and the remaining diodes are lighting diodes 10. A part of the bulb housing 90 close to the indication diode 30 is transparent, such that the state of the indication diode 30 can be observed. For example, a user can visually see from the outside of the bulb whether the indication diode 30 is turned on.

As another example, the lighting diode 10 is located on the circuit board 100 inside the bulb housing, the indication diode 30 is located inside an insulation body 110 of the bulb, and a part of the insulation body 110 is transparent, such that the state of the indication diode 30 can be observed.

If the lighting diode 10 cannot work normally due to a fault, the indication diode 30 will also turn on to act as an indication to the user.

The present disclosure can prompt the user of a safety risk at the end of life of the lamp only by means of the structure of the lamp itself without the aid of an additional device, thereby avoiding the eye fatigue of the user.

In the embodiments of the present disclosure, a technical solution, in which the lighting duration of the lighting diode is accumulated by the controller, and the accumulated lighting duration being equal to or greater than the rated lighting lifespan is indicated by the indication diode, is provided, which at least solves the technical problem in the prior art that a lighting device has a safety risk at the end of life, thereby achieving the technical effects of simply and effectively indicating the lighting lifespan, avoiding potential safety risks of the lighting device, avoiding eye fatigue of the user, and improving the sales volume of the lighting device.

In the embodiments of the present disclosure, the illustration of each embodiment has its own emphasis. For the part not detailed in a certain embodiment, please refer to the relevant illustration in other embodiments.

In the several embodiments provided in the present disclosure, it should be understood that the disclosed technical content may be implemented in other manners.

The content above only relates to preferred embodiments of the present disclosure. It should be noted that for a person of ordinary skill in the art, several improvements and modifications can also be made without departing from the principle of the present disclosure, and these improvements and modifications shall also be considered as within the scope of protection of the present disclosure.

1. A lighting device capable of indicating lighting lifespan, the lighting device comprising:
a lighting diode, having a rated lighting lifespan, and the lighting diode being connected to an external power source to receive power from the external power source to emit light;
a controller, connected to the lighting diode so as to accumulate a lighting duration of the lighting diode when the lighting diode receives power to emit light; and
an indication diode, connected to the controller to receive a control signal from the controller, the control signal controlling the on, off or brightness change of the indication diode;
wherein the controller compares the rated lighting lifespan and the accumulated lighting duration of the lighting diode, and when the accumulated lighting duration is equal to or greater than the rated lighting lifespan, the control signal is sent.

2. The lighting device according to claim 1, wherein the lighting device further comprises an MOS transistor, wherein a source of the MOS transistor is connected to the lighting diode, a gate thereof is connected to the controller and a drain thereof is connected to the indication diode, so as to adjust a current flowing through the indication diode.

3. The lighting device according to claim 1, wherein the lighting device further comprises a bridge rectifier connected between the external power source and the lighting diode, the bridge rectifier rectifying an alternating current of the external power source to a direct current adapted to the lighting diode.

4. The lighting device according to claim 1, wherein the lighting device further comprises a lighting power supply module connected between a positive electrode of the external power source and a positive electrode of the lighting diode, wherein the lighting power supply module supplies power to the lighting diode.

5. The lighting device according to claim 1, wherein the lighting power supply module is a constant current source, such that a current flowing through the lighting diode is constant.

6. The lighting device according to claim 2, wherein the controller is a microcontroller unit, and when the accumulated lighting duration is equal to or greater than the rated lighting lifespan, a relevant port state of the microcontroller unit changes to indicate that the indication diode is turned on.

7. The lighting device according to claim 2, wherein the lighting device further comprises a controller power supply module connected between a positive electrode of the external power source and the controller, wherein the controller power supply module converts a current from the external power source to drive the controller.

8. The lighting device according to claim 2, wherein the number of the lighting diodes is one or more.

9. The lighting device according to claim 8, wherein when there are a plurality of lighting diodes, the plurality of lighting diodes are connected in series or in parallel.

10. The lighting device according to claim 2, wherein the lighting diodes comprise red diodes emitting red light, green diodes emitting green light, or blue diodes emitting blue light.

11. The lighting device according to claim 2, wherein the indication diode is one indication diode, or a plurality of indication diodes connected in series.

12. The lighting device according to claim 1, wherein the lighting device is a bulb, the lighting diode is located inside a bulb housing of the bulb, and the indication diode is located at a position near the bulb housing of the bulb.

13. The lighting device according to claim 12, wherein the lighting diode is located on a circuit board within the bulb housing, and the indication diode is located at a position on an edge of the circuit board and near the bulb housing.

14. The lighting device according to claim 13, wherein a part of the bulb housing close to the indication diode is transparent, such that the state of the indication diode can be observed.

15. The lighting device according to claim 12, wherein the lighting diode is located on a circuit board inside the bulb housing, the indication diode is located inside an insulation body of the bulb, and a part of the insulation body is transparent, such that the state of the indication diode can be observed.

16. The lighting device according to claim 1, wherein the controller is connected in parallel to the lighting diode, and the indication diode is arranged on a parallel branch where the controller is located.

17. A lighting device, comprising:
a lighting end connecting without power supply;
an insulation body;
a bulb housing, at least partly transparent;
lighting diode and a controller, which being mounted in the space formed by insulation body and bulb housing;
the lighting diode, having a rated lighting lifespan, the controller, connected to the lighting diode so as to accumulate a lighting duration of the lighting diode when the lighting diode receives power to emit light; an indication diode, being located at a position near the bulb housing and connected to the controller to receive a control signal from the controller;
wherein the controller compares the rated lighting lifespan and the accumulated lighting duration of the lighting diode, and when the accumulated lighting duration is equal to or greater than the rated lighting lifespan, the control signal is sent.

18. The lighting device according to claim 17, wherein the indication diode is formed in insulation housing near to the bulb which the insulation housing is partly transparent.

19. The lighting device according to claim 17, wherein an indication diode, connected between the controller and a negative electrode of the external power source to receive a control signal from the controller, the control signal controlling the on, off or brightness change of the indication diode.

20. The lighting device according to claim 19, wherein the lighting device further comprises an MOS transistor, wherein a source of the MOS transistor is connected to the lighting diode, a gate thereof is connected to the controller and a drain thereof is connected to the indication diode, so as to adjust a current flowing through the indication diode.
